(19) United States
(12) Patent Application Publication
(10) Pub. No.: US 2002/0010516 A1
(43) Pub. Date: Jan. 24, 2002

(54) Irrigation controller using regression model

(76) Inventors: John Addink, Riverside, CA (US); Tony Givargis, Anaheim Hills, CA (US)

Correspondence Address: Robert D. Fish, Suite 706, 1440 N. Harbor Blvd., Fullerton, CA, 92835, US

(21) Appl. No.: 09/759,788

(22) Filed: Jan. 11, 2001

(30) Foreign Application Priority Data
Jul. 7, 2000 (US) PCT/US00/18705

(51) Int. Cl. G05B 11/01

(52) U.S. Cl. 700/19

(57) ABSTRACT

The present invention provides systems and methods in which an irrigation controller uses a regression model to estimate an evapotranspiration rate (estimated ETo), and uses the estimated ETo to affect an irrigation schedule executed by the controller. The regression model is preferably based upon a comparison of historical ETo values against corresponding historical environmental values, with the data advantageously spanning a time period of at least one month, and more preferably at least two months. Data for multiple environmental factors may also be used. The environmental factor(s) utilized may advantageously comprise one or more of temperature, solar radiation, wind speed, humidity, barometric pressure, cloud cover and soil moisture. Values relating the environmental factor(s) may enter the controller from a local sensor, a distal signal source, or both.

This application claims priority to PCT patent application Ser. No. PCT/US00/18705 filed on Jul. 7, 2000.

### FIELD OF THE INVENTION

The field of the invention is irrigation controllers.

### BACKGROUND OF THE INVENTION

In arid areas of the world water is becoming one of the most precious natural resources. Meeting future water needs in these arid areas may require aggressive conservation measures. One useful aspect of conservation involves limiting the water applied to a landscape in an amount close to the actual water requirements of the plants being irrigated. However, very few irrigation controllers marketed today execute a water schedule that closely meet the actual water requirement of plants.

Many irrigation controllers have been developed for automatically controlling application of water to landscapes. Known irrigation controllers range from simple devices that control watering times based upon fixed schedules, to sophisticated devices that vary the watering schedules according to local geography and climatic conditions.

With respect to the simpler types of irrigation controllers, a homeowner typically sets a watering schedule that involves specific run times and days for each of a plurality of stations, and the controller executes the same schedule regardless of the season or weather conditions. From time to time the homeowner may manually adjust the watering schedule, but such adjustments are usually only made a few times during the year, and are based upon the homeowner's perceptions rather than the actual watering needs. One change is often made in the late Spring when a portion of the yard becomes brown due to a lack of water. Another change is often made in the late Fall when the homeowner assumes that the vegetation does not require as much watering. These changes to the watering schedule are typically insufficient to achieve efficient watering.

Sophisticated irrigation controllers usually include some mechanism for automatically making adjustments to the irrigation run times to account for daily environmental variations. One common adjustment is based on soil moisture. It is common, for example, to place sensors locally in the soil, and suspend irrigation as long as the sensor detects moisture above a given threshold. Controllers of this type help to reduce over irrigating, but placement of the sensors is critical to successful operation.

More sophisticated irrigation controllers are known that employ evapotranspiration values for determining the amount of water to be applied to a landscape. Evapotranspiration (ETo) is the water lost by direct evaporation from the soil and plant and by transpiration from the plant surface. There are several closely related terms used herein with respect to evapo-transpiration. “Actual ETo” is the amount of water actually lost by a sample. At present, actual ETo must be measured using a lysimeter or equivalent. “Potential ETo” is a calculated approximation of actual ETo, using one of the well accepted formulas, Penman-Monteith, Hargraeves, Blaney-Criddle, Thomthwaite, Jensen-Haise, Priestley-Taylor, Turc, FAO-24 Radiation, and so forth. “Historical ETo” is the potential or actual ETo for a given area. “Estimated ETo” is an estimate of potential ETo, such as that derived from a regression analysis.

Irrigation controllers that derive all or part of the irrigation schedule from potential evapotranspiration data are discussed in U.S. Pat. No. 5,479,339 issued December 1995 to Miller, U.S. Pat. No. 5,097,861 issued March 1992 to Hopkins, et al., U.S. Pat. No. 5,023,787 issued June 1991 and U.S. Pat. No. 5,229,937 issued July 1993 both to Evelyn-Veere, U.S. Pat. No. 5,208,855, issued May 1993, to Marian, U.S. Pat. No. 5,696,671, issued December 1997, and U.S. Pat. No. 5,870,302, issued February 1999, both to Oliver and U.S. Pat. No. 6,102,061, issued August, 2000 to Addink.

Because of cost and/or complicated operating requirements of controllers that derive all or part of the irrigation schedule from ETo data, most residential and small commercial landscape sites are primarily irrigated by controllers that provide inadequate schedule modification. This results in either too much or too little water being applied to the landscape, which in turn results in both inefficient use of water and unnecessary stress on the plants. Therefore, a need exists for a cost-effective irrigation system for residential and small commercial landscape sites that is capable of frequently varying the irrigation schedule based upon estimates of a plant's water requirements.

### SUMMARY OF THE INVENTION

The present invention provides systems and methods in which an irrigation controller uses a regression model to estimate an evapotranspiration rate (estimated ETo), and uses the estimated ETo to affect an irrigation schedule executed by the controller.

The regression model is preferably based upon a comparison of historical ETo values against corresponding historical environmental values, with the data advantageously spanning a time period of at least two days, and more preferably at least one month. Data from multiple environmental factors may also be used. Alternatively, the regression model may use Hargreave's formula, Thornthwaite's formula or any other present or future formulas for determining estimated ETo.

The environmental factor(s) utilized may advantageously comprise one or more of temperature, solar radiation, wind speed, humidity, barometric pressure, cloud cover and soil moisture. Temperature may either be air temperature or soil temperature. Values relating the environmental factor(s) may enter the controller from a local sensor, a distal signal source, or both.

The mechanism may use other values, in addition to the environmental value(s), including a crop coefficient value and an irrigation efficiency value, to affect the irrigation schedule executed by the controller.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a flow chart of a preferred embodiment of a method of the present invention.

FIG. 2 is a flow chart of an alternative embodiment of a method of the present invention.

FIG. 3 is a figure showing an exemplary relationship of ETo versus temperature.

FIG. 4 is a flow chart of the steps in the determination of a regression model, which would be programmed in irrigation controllers.

FIG. 5 is a map depicting how California might be divided into zones with similar evapotranspiration characteristics, and the location of a representative weather station within each zone.

FIG. 6 is a schematic of an irrigation controller.

FIG. 7 is a flow chart of an irrigation system according to the present invention.

FIG. 8 is a figure showing an exemplary comparison between estimated ETo values determined according to the present invention and potential ETo values for 1999 from a weather station located at Merced, Calif.

### DETAILED DESCRIPTION

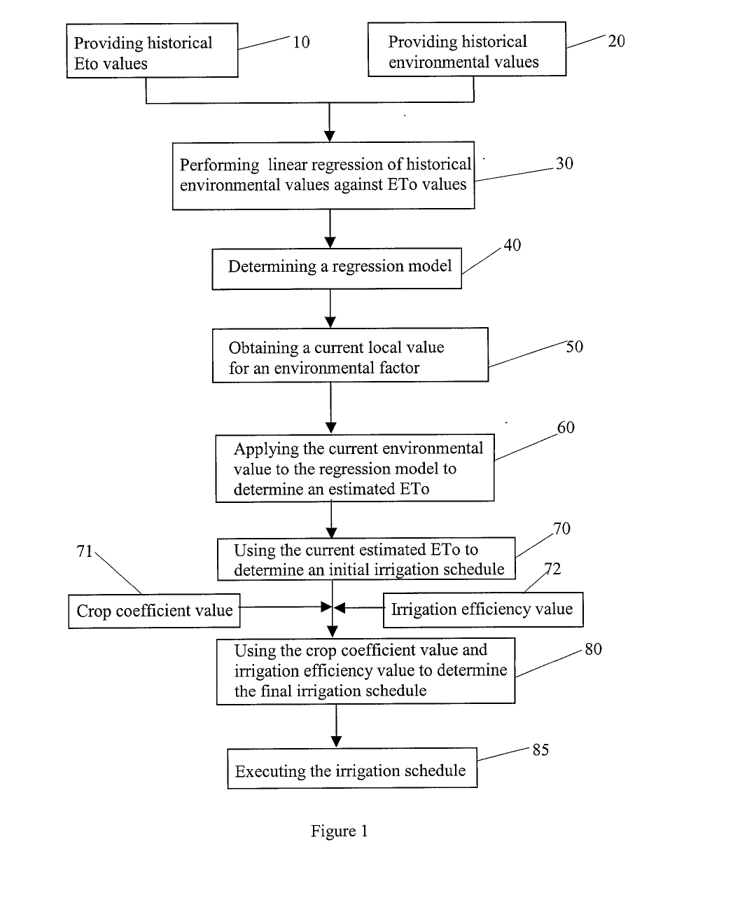

In FIG. 1 a preferred method of controlling irrigation run time generally comprises: providing historical ETo values 10; providing corresponding environmental values 20; performing a linear regression for the historical ETo values and the historical environmental values 30; determining a regression model 40; obtaining a current local value for an environmental factor 50; applying that value to the regression model 60 to estimate current ETo 60; using the current estimated ETo to determine the initial irrigation schedule 70; using the crop coefficient value 71 and the irrigation efficiency value 72 to determine a final irrigation schedule 80; and then executing the irrigation schedule 85.

The historical ETo values may be obtained from a number of sources, including government managed weather stations such as CIMIS (California Irrigation Management Information System, maintained by the California Department of Water Resources), CoAgMet maintained by Colorado State University-Atmospheric Sciences, AZMET maintained by University of Arizona-Soils, Water and Environmental Science Department, New Mexico State University-Agronomy and Horticulture, and Texas A&M University-Agricultural Engineering Department. Although variations in the methods used to determine the ETo values do exist, most potential ETo values are based on the Penman-Monteith formula or some variation of the Penman-Monteith formula, which generally utilizes the following environmental factors: temperature, solar radiation, wind speed, vapor pressure or humidity, and barometric pressure.

Alternative formulas used for determining potential ETo include Hargraeves, Blaney-Criddle, Thomthwaite, Jensen-Haise, Priestley-Taylor, Turc, FAO-24 Radiation, and so forth. These formulas are explained in Evapotranspiration and Irrigation Water Requirements. ASCE Manuals and Reports on Engineering Practice No. 70, 1990 and Hargreaves, G. H. 1994. Defining and Using Reference Evapotranspiration. Journal of Irrigation and Drainage Engineering, Volume 120, No. 6:1132-1139.

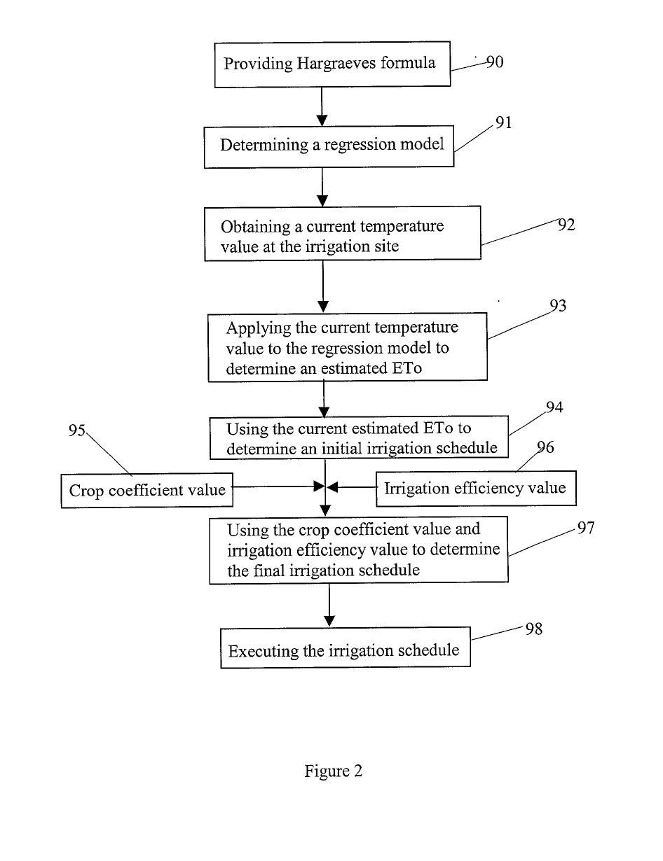

In FIG. 2 an alternative method of controlling irrigation run time comprises: providing a formula, such as Hargraeves 90; determining a regression model based on Hargraeves formula 91; obtaining a current temperature value 92; applying that value to the regression model to estimate current ETo 93; using the current estimated ETo to determine the initial irrigation schedule 94; using the crop coefficient value 95 and the irrigation efficiency value 96 to determine a final irrigation schedule 97, and then executing the irrigation schedule 98.

As mentioned above, the Penman-Monteith formula requires data from a minimum of the following four meteorological factors; temperature, solar radiation, wind speed and relative humidity. However, there are many locations throughout the world where irrigation systems are used that do not have weather stations that provide the four meteorological factors. Therefore, there are times when the regression model could advantageously be based on other formulas such as Hargraeves, which only requires temperature data for the estimating of ETo.

The equation for Hargreaves formula is ETo=0.0023×RA×(T°C+17.8)×TD^{0.50} in which ETo and RA=same units of equivalent water evaporation; RA=extraterrestrial radiation; TD=Tₘₓ−Tₘᵢ (mean maximum minus mean minimum temperatures in degrees Celsius); and T°C is (Tₘₓ+Tₘᵢ)/2. Values of RA (in mm/day) are obtained from a Table. (See Hargreaves, G. H. 1994. Defining and Using Reference Evapotranspiration. Journal of Irrigation and Drainage Engineering, Volume 120, No. 6:1132-1139.)

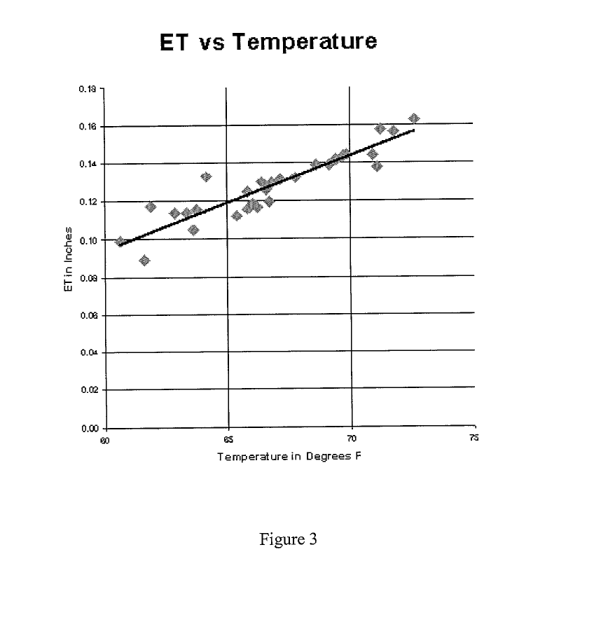

FIG. 3 shows an exemplary relationship of temperature versus ETo over a month. An increase in temperature generally results in an increase in the ETo value, with the opposite occurring upon a decrease in temperature. The other factors have greater or lesser effects than temperature on ETo, but all have some effect on ETo, and each of the environmental factors can be used in the determination of a regression model.

Regression analysis can be performed on any suitable time period. Several years of data is preferred, but shorter time spans such as several months, or even a single month, can also be used. Different regression models can also be generated for different seasons during the year, for different geographic zones, and so forth.

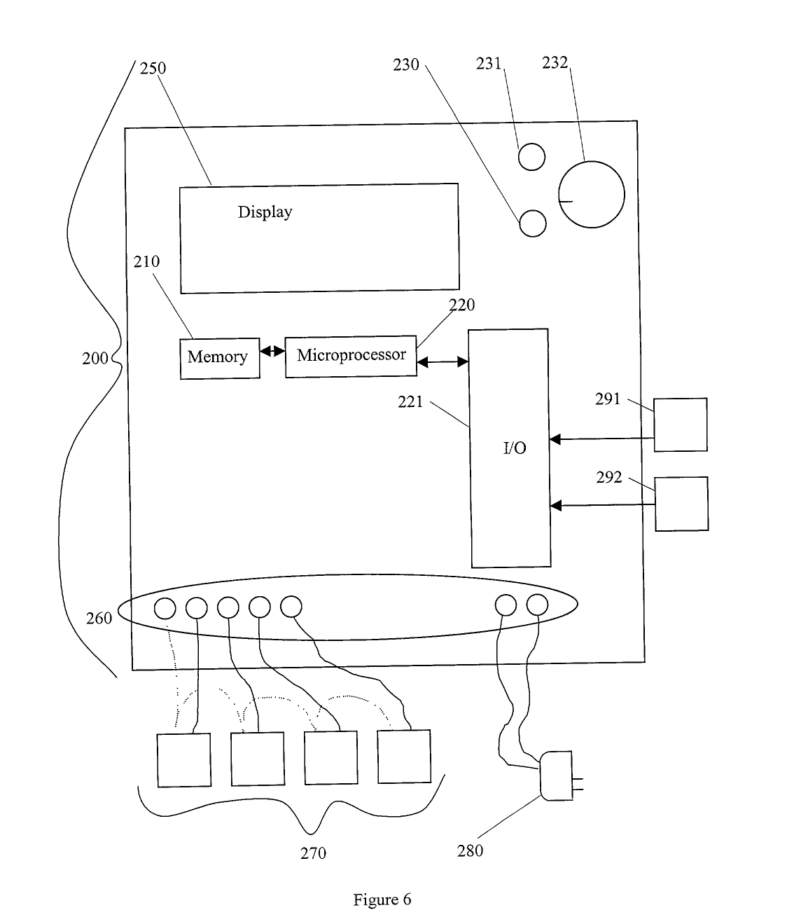

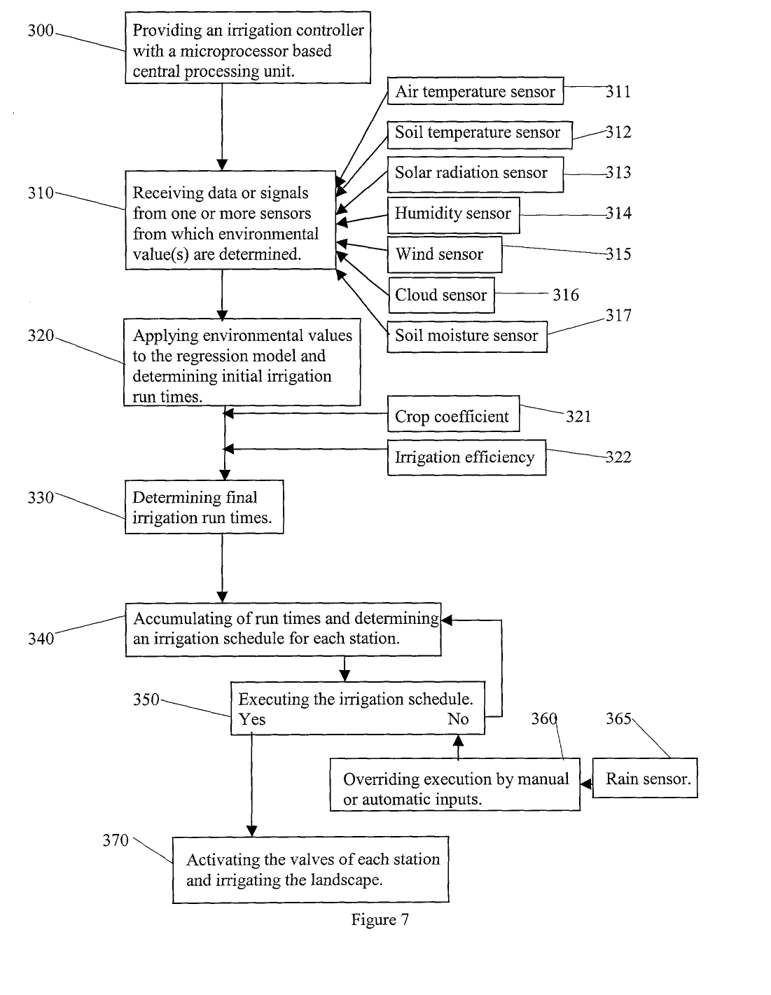

The regression model is preferably programmed into the central processing unit or memory of the irrigation controller using a suitable microcode (See FIG. 6, 220 and 210). The value or values applied against the regression model are preferably obtained from one or more local sensors (See FIG. 7, steps 311 through 317). The microprocessor based central processing unit may have conventional interface hardware for receiving and interpreting of data or signals from such sensors.

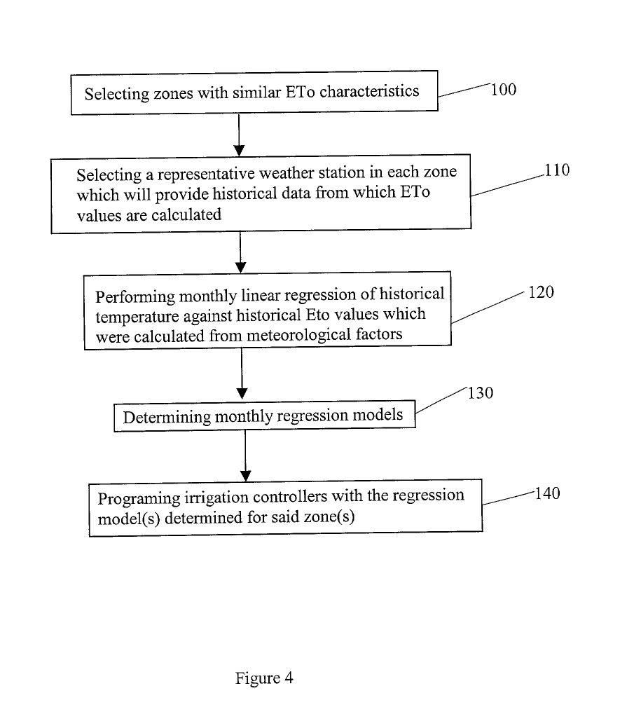

In FIG. 4 an early step in a preferred determination of a regression model that will be programmed in the microprocessor of an irrigation controller is to select zones with similar evapotranspiration characteristics, step 100. A representative weather station, which provides ETo values, is selected in the zone, step 110. Preferably, monthly linear regression is performed of historical temperature values against the historical ETo values, step 120. Alternatively, it is contemplated that bimonthly, quarterly, or other time periods may be used in performing the linear regression of historical temperature values against the historical ETo values. Additionally, it is contemplated that multiple regression or other regression analysis may be used in the determination of the regression relationships between historical temperature values and historical ETo values or when using Hargraeves formula or other formulas to determine estimated ETo.

Monthly regression models can be determined from these monthly regression relationships, step 130. All irrigation controllers located in a specific zone can then be programmed with the regression models determined for that zone, step 140.

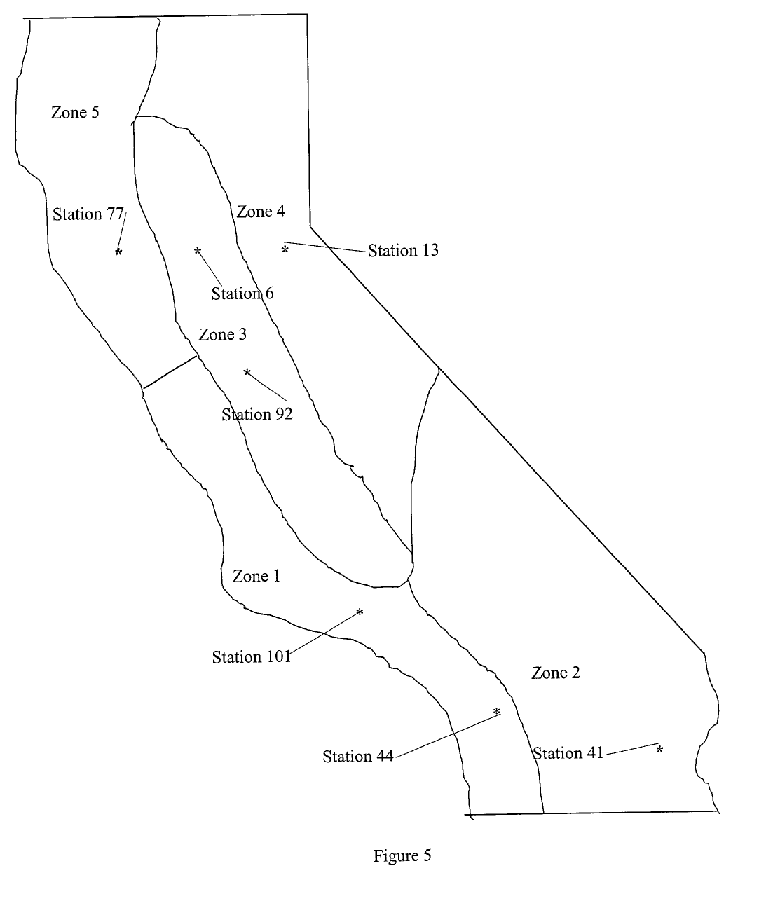

FIG. 5 is a map depicting how California might be divided into zones with similar evapotranspiration characteristics, and the location of a representative weather station within each zone.

FIG. 6 is a schematic of an irrigation controller programmed with a regression model that, along with other inputs and/or adjustments, would determine the run times for the various stations controlled by the irrigation controller. A preferred embodiment of an irrigation controller 200 generally includes a microprocessor based central processing unit 220, an on-board memory 210, some manual input devices 230 through 232 (buttons and or knobs), an input/output (I/O) circuitry 221 connected in a conventional manner, a display screen 250, electrical connectors 260 which are connected to a plurality of irrigation stations 270 and a power supply 280, a rain detection device 291, and an environmental sensor 292. Each of these components by itself is well known in the electronic industry, with the exception of the programming of the microprocessor in accordance with the functionality set forth herein. There are hundreds of suitable chips that can be used for this purpose. At the present, experimental versions have been made using a generic Intel 80C54 chip, and it is contemplated that such a chip would be satisfactory for production models.

In a preferred embodiment of the present invention the controller has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with peripheral devices and measurement equipment including but not limited to water flow sensors, water pressure sensors, and temperature sensors.

When the irrigation controller is installed an irrigation schedule is programmed into the controller, and is stored in the memory. In a preferred embodiment of the present invention the irrigation schedule is modified during the year to execute an irrigation of the landscape that meets the water requirements of the landscape plants with a minimum waste of water.

FIG. 7 is a flow chart of an irrigation system according to the present invention. The flow chart starts with step 300 providing an irrigation controller (See FIG. 6, 200), with a microprocessor based central processing unit 220, such as that described above. Step 310 is the receiving of data or signals from at least one environmental sensor from which are determined environmental value(s). The sensors from which data or signals are received include air temperature, soil temperature, solar radiation, relative humidity, wind speed, barometric pressure, cloud cover and soil moisture sensors 311-317. At least one of these environmental values is applied to the regression model and the initial run times are determined by the microprocessor 320. A final irrigation run time is determined based on a crop coefficient value 321 and an irrigation efficiency value 322, step 330. It is contemplated that the microprocessor can be preprogrammed to prevent the controller from activating the valves to irrigate the landscape until an adequate irrigation run time has accumulated to permit for the deep watering of the soil 340. When an adequate irrigation run time has been accumulated the controller will activate the valves to each station and the landscape will be irrigated, except when a manual or automatic override of irrigation occurs, steps 350 through 370.

In step 310, the data or signals are preferably received locally by a direct hardwire connection between the irrigation controller and the sensors, but they may be received by any suitable wireless link, such as optical, radio, hydraulic or ultrasonic. Further, it is contemplated that some or all of the environmental data may be received using distally transmitted signals. Such signals are most likely received by radio wave, perhaps as sub-signals on commercial broadcasts, or as main signals from a weather transmitting station. The distal signals may be transmitted by any suitable mechanism, including the Internet, telephone line, pager, two-way pager, cable, or TV carrier wave.

Because crop species vary in their moisture requirements, a crop coefficient value 321 is preferably assigned to the crop to be irrigated and this crop coefficient value 321 is used at least partly to modify the initial irrigation run times in arriving at a final irrigation run time 330. Additionally, irrigation systems are not 100% efficient in the application of water to a landscape. Therefore, an irrigation efficiency value 322 is determined for the irrigation system and preferably this also is a part of the calculation used to modify the initial irrigation run times in arriving at a final irrigation run time 330.

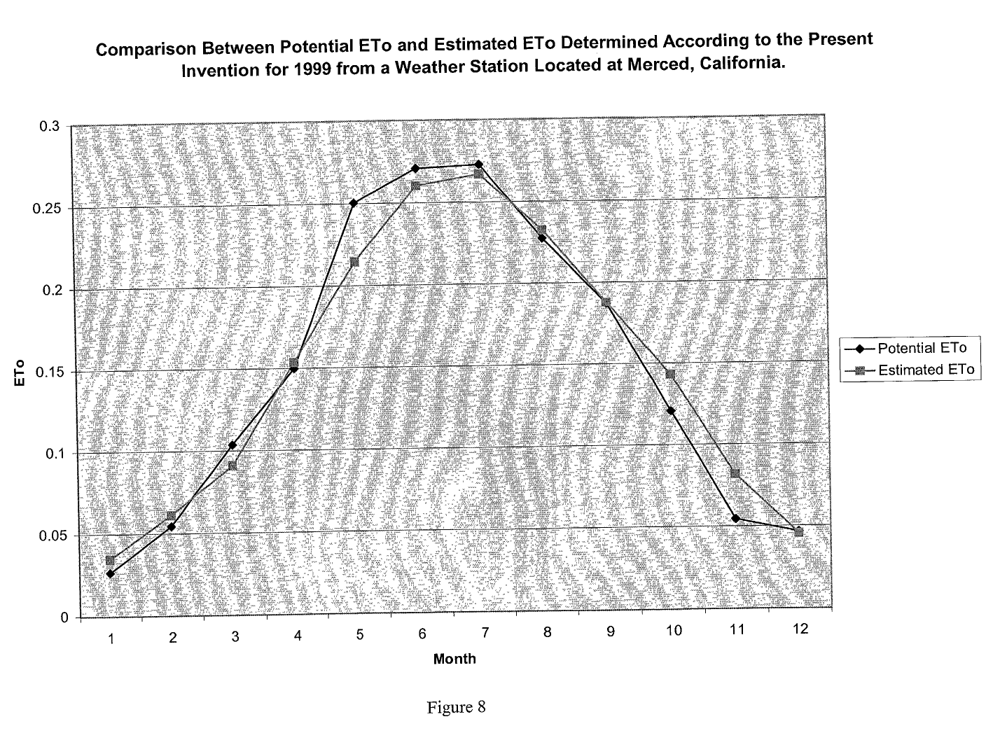

FIG. 8 is a comparison between potential ETo values determined by the Penman-Monteith formula and ETo values determined according to the present invention for 1999 data from a weather station located at Merced, Calif. As the figure indicates, some differences do exist between potential ETo values and ETo values determined by the present invention. However, landscapes receiving irrigation based on the present invention, would receive close to the right amount of water required to maintain the plants in a healthy condition and with a reduced waste of water.

A major advantage of controllers as described herein is that a user can confidently avoid the hassles attendant upon manually modifying the controller settings to accommodate changing environmental conditions. This advantage is contemplated to spill over into greater emotional happiness of the user, especially in situations where the person responsible for modifying the controller is subject to reprimands in a work or interpersonal relationship. Thus, one particularly contemplated method involves improving harmony in a marriage comprising installing a controller as described herein at a residence of a married couple.

It is also especially contemplated that an irrigation system for a residential or small commercial landscape, defined herein to have no more than 8, 12, or 16 irrigation stations (i.e. zones), may advantageously include a controller as described herein.

Thus, specific embodiments and applications of irrigation controllers using regression models have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An irrigation controller comprising:
a memory that stores a regression model;
a microprocessor that applies a value for an environmental factor to the regression model to estimate an evapotranspiration rate (estimated ETo); and
a mechanism that uses the estimated ETo to affect an irrigation schedule executed by the controller.

2. The controller of claim 1 wherein the regression model is based at least in part upon a set of historical ETo values and a set of corresponding historical values for the environmental factor.

3. The controller of claim 2 wherein the set of historical ETo values spans a time period of at least two days.

4. The controller of claim 2 wherein the regression model is further based upon a second set of historical values for a second environmental factor.

5. The controller of claim 1 wherein the regression model comprises a linear regression.

6. The controller of claim 1 wherein the regression model comprises a multiple regression.

7. The controller of claim 1 wherein the regression model is based on Hargreave's formula for determining estimated ETo.

8. The controller of claim 1 wherein the regression model is based on Thomthwaite's formula for determining estimated ETo.

9. The controller of claim 1 wherein the environmental factor is at least one of temperature, solar radiation, wind speed, humidity, barometric pressure, cloud cover, and soil moisture.

10. The controller of claim 9 wherein the temperature is air temperature.

11. The controller of claim 9 wherein the temperature is soil temperature.

12. The controller of claim 2 wherein the environmental factor is selected from the group consisting of temperature, solar radiation, wind speed, humidity, barometric pressure, cloud cover and soil moisture.

13. An irrigation system comprising an irrigation controller according to claim 1, and a local sensor that provides a signal corresponding to the value for the environmental factor.

14. An irrigation system comprising an irrigation controller according to claim 1, and a receiver that receives from a distal source a signal corresponding to the value for the environmental factor.

15. The controller of claim 1, further comprising the mechanism using an irrigation efficiency value to at least partly affect the irrigation schedule executed by the controller.

16. The controller of claim 1, further comprising the mechanism using a crop coefficient value to at least partly affect the irrigation schedule executed by the controller.

17. A method of improving harmony in a marriage comprising installing the controller in claim 1 at a residence of a married couple.

18. A residential irrigation system having a controller according to claim 1, and having no more than 8 irrigation stations.
